(19) United States
(12) Patent Application Publication
(10) Pub. No.: US 2026/0142399 A1
(43) Pub. Date: May 21, 2026

(54) CONNECTOR ASSEMBLY

(71) Applicant: SUMITOMO WIRING SYSTEMS, LTD., Mie (JP)

(72) Inventor: Shota KANBARA, Mie (JP)

(21) Appl. No.: 19/391,115

(22) Filed: Nov. 17, 2025

(30) Foreign Application Priority Data
Nov. 18, 2024 (JP) 2024-200336

(51) Int. Cl. H01R 13/424; H01R 13/10; H01R 13/426

(52) U.S. Cl. CPC H01R 13/424; H01R 13/10; H01R 13/426

(57) ABSTRACT

A connector assembly includes: a frame that has a plurality of accommodating portions; and a sub-connector that has a locking protrusion. Each accommodating portion has an elastic portion and a lock claw. As a result of the elastic portion bending, the lock claw moves to a bent position in which the lock claw does not engage with the locking protrusion, and, as a result of being positioned in the normal position, the lock claw engages with the locking protrusion so as to prevent disengagement of the sub-connector from the accommodating portion. The lock claw includes a first lock claw and a second lock claw that are respectively provided to adjacent ones of the accommodating portions such that the first lock claw and the second lock claw face one another between the adjacent accommodating portions.

### CROSS-REFERENCE TO RELATED APPLICATIONS

This application is based on and claims priority from Japanese Patent Application No. 2024-200336, filed on November 18, 2024, with the Japan Patent Office, the disclosure of which is incorporated herein in its entirety by reference.

### TECHNICAL FIELD

The present disclosure relates to a connector assembly.

### BACKGROUND

Conventionally, there is known a connector assembly including a frame that has a plurality of accommodating portions, and a sub-connector that is configured to be capable of being inserted into each of the plurality of accommodating portions (see JP 2005-071806 A). This sub-connector has a locking protrusion that projects in a direction intersecting an insertion axis to the accommodating portion. Furthermore, the accommodating portion has an elastic portion and a lock claw. The lock claw permits the insertion of the sub-connector to the accommodating portion by, as a result of the elastic portion bending, moving from a normal position to a bent position in which the lock claw does not engage with the locking protrusion. Furthermore, as a result of being positioned in the normal position in a completely inserted state in which the sub-connector has been inserted into the accommodating portion, the lock claw engages with the locking protrusion so as to prevent the disengagement of the sub-connector from the accommodating portion.

### SUMMARY

However, in a connector assembly as described above, the elastic portion is a single elastic piece that is connected to the lock claw and that bends in a tilting manner by being connected to a single fulcrum; due to this, the elastic portion is bent significantly even under a small force. Due to this, for example, the elastic portion is susceptible to damage.

One aim of the present disclosure is to provide a connector assembly configured to be capable of holding a sub-connector stably.

A connector assembly according to the present disclosure is a connector assembly including: a frame that has a plurality of accommodating portions; and a sub-connector that is configured to be capable of being inserted along an insertion axis to each of the plurality of accommodating portions, the sub-connector having a locking protrusion that projects in a direction intersecting the insertion axis, wherein each of the plurality of accommodating portions has an elastic portion and a lock claw, as a result of the elastic portion bending, the lock claw moves from a normal position to a bent position in which the lock claw does not engage with the locking protrusion, and, as a result of being positioned in the normal position in a completely inserted state in which the sub-connector has been inserted into the accommodating portion, the lock claw engages with the locking protrusion so as to prevent disengagement of the sub-connector from the accommodating portion, the lock claw includes a first lock claw and a second lock claw that are respectively provided to adjacent ones of the accommodating portions such that the first lock claw and the second lock claw face one another between the adjacent accommodating portions, the first lock claw is provided so that the first lock claw prevents the second lock claw from moving to the bent position when the first lock claw is in the bent position, and the first lock claw prevents the second lock claw from moving beyond the bent position when the first lock claw is in the normal position, and the elastic portion is provided at both sides of the lock claw.

According to the connector assembly according to the present disclosure, a sub-connector can be held stably.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector assembly in one embodiment.

FIG. 2 is an exploded perspective view of the connector assembly in one embodiment.

FIG. 3 is a plan view of a frame in one embodiment.

FIG. 4 is a plan view of the connector assembly in one embodiment.

FIG. 5 is a partially enlarged perspective view of an accommodating portion in one embodiment.

FIG. 6 is a cross-sectional view taken along line 6-6 in FIG. 3.

FIG. 7 is a cross-sectional view taken along line 7-7 in FIG. 3.

FIG. 8 is a cross-sectional view taken along line 8-8 in FIG. 4.

FIG. 9 is a cross-sectional diagram for explaining actions of an elastic portion and a lock claw.

FIG. 10 is a cross-sectional diagram for explaining actions of the elastic portion and the lock claw.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### [Description of Embodiments of Present Disclosure]

First, aspects of the present disclosure will be listed and described.

(1) A connector assembly according to the present disclosure is a connector assembly including: a frame that has a plurality of accommodating portions; and a sub-connector that is configured to be capable of being inserted along an insertion axis to each of the plurality of accommodating portions, the sub-connector having a locking protrusion that projects in a direction intersecting the insertion axis, wherein each of the plurality of accommodating portions has an elastic portion and a lock claw, as a result of the elastic portion bending, the lock claw moves from a normal position to a bent position in which the lock claw does not engage with the locking protrusion, and, as a result of being positioned in the normal position in a completely inserted state in which the sub-connector has been inserted into the accommodating portion, the lock claw engages with the locking protrusion so as to prevent disengagement of the sub-connector from the accommodating portion, the lock claw includes a first lock claw and a second lock claw that are respectively provided to adjacent ones of the accommodating portions such that the first lock claw and the second lock claw face one another between the adjacent accommodating portions, the first lock claw is provided so that the first lock claw prevents the second lock claw from moving to the bent position when the first lock claw is in the bent position, and the first lock claw prevents the second lock claw from moving beyond the bent position when the first lock claw is in the normal position, and the elastic portion is provided at both sides of the lock claw.

According to this configuration, the first lock claw prevents the second lock claw from moving to the bent position when the first lock claw is in the bent position; thus, for example, the sub-connector can be prevented from being inserted into the accommodating portion having the second lock claw when the first lock claw is in the bent position. Accordingly, for example, a worker can sense that the sub-connector is in a semi-inserted state in the accommodating portion having the first lock claw based on the insertion of the sub-connector to the accommodating portion having the second lock claw being impossible. Furthermore, the first lock claw prevents the second lock claw from moving beyond the bent position when the first lock claw is in the normal position; thus, for example, a situation such as that in which the elastic portion connected to the second lock claw is damaged by being bent excessively can be prevented. Furthermore, the elastic portion is provided at both sides of the lock claw; thus, a situation in which the elastic portion is bent significantly under a small force can be prevented compared to a case in which the elastic portion is a single elastic piece that is connected to the lock claw and that bends in a tilting manner by being connected to a single fulcrum, for example. Accordingly, for example, a situation in which the second lock claw moves beyond the bent position when the first lock claw is in the normal position can be firmly prevented. Due to the above, the elastic portion is less susceptible to damage, and, consequently, the sub-connector can be held stably.

(2) In (1) above, the elastic portion may include a pair of side elastic walls that extend in directions away from one another from opposite sides of the lock claw and that are connected to a pair of opposing surfaces forming an inner surface of the accommodating portion.

According to this configuration, the elastic portion includes a pair of side elastic walls that extend in directions away from one another from opposite sides of the lock claw and that are connected to a pair of opposing surfaces forming an inner surface of the accommodating portion; thus, a situation in which the elastic portion is bent significantly under a small force can be prevented. That is, unlike a single elastic piece that is connected to the lock claw and that bends in a tilting manner by being connected to a single fulcrum, for example, the pair of side elastic walls do not readily bend due to the interaction therebetween, even though the side elastic walls are configured to be thin. Accordingly, for example, a situation in which the second lock claw moves beyond the bent position when the first lock claw is in the normal position is firmly prevented. Due to the above, the elastic portion is even less susceptible to damage, and, consequently, the sub-connector can be held more stably.

(3) In (2) above, the elastic portion may include a pair of insertion-axis elastic walls that extend along the insertion axis from the side elastic walls and the opposite sides of the lock claw.

According to this configuration, the elastic portion includes a pair of insertion-axis elastic walls that extend along the insertion axis from the side elastic walls and the opposite sides of the lock claw; thus, a situation in which the elastic portion is bent significantly under a small force can be prevented to a further extent compared to a configuration in which the insertion-axis elastic walls are not included, for example.

(4) In any one of (1) to (3) above, the lock claw may be provided at an end portion of the accommodating portion from which the sub-connector is inserted.

According to this configuration, the lock claw is provided at an end portion of the accommodating portion from which the sub-connector is inserted; thus, for example, a worker can visually check whether or not the lock claw is in the normal position from the direction in which the sub-connector has been inserted into the accommodating portion. Accordingly, for example, after inserting the sub-connector into the accommodating portion, the worker can easily check whether the sub-connector is in the completely inserted state or the semi-inserted state without turning over the connector assembly.

(5) According to any one of (1) to (4) above, the sub-connector may have an abutting portion at a middle portion thereof along the insertion axis, and the accommodating portion may have a receiving portion that the abutting portion abuts against in the completely inserted state, in which the sub-connector has been inserted into the accommodating portion.

According to this configuration, the sub-connector has an abutting portion at a middle portion thereof along the insertion axis, and the accommodating portion has a receiving portion that the abutting portion abuts against when the sub-connector is in the completely inserted state; thus, an end portion of the sub-connector that is inserted into the accommodating portion can be exposed. In other words, a configuration can be obtained in which the end portion of the sub-connector that is inserted into the accommodating portion is not covered by the accommodating portion. Accordingly, in comparison with a configuration in which the end portion of the sub-connector that is inserted into the accommodating portion is covered by the accommodating portion, for example, the effective contact length between terminals held by the sub-connector and mating terminals of a mating connector to be fitted to the connector assembly can be increased. That is, with a configuration in which the end portion of the sub-connector that is inserted into the accommodating portion is covered by the accommodating portion, it would be difficult to increase the effective contact length with the mating terminals because the terminals would be located further inward; however, the effective contact length can be increased by avoiding such a situation.

### [Details of Embodiment of Present Disclosure]

Specific examples of the connector assembly according to the present disclosure will be described below with reference to the drawings. In the drawings, some configurations may be illustrated in an exaggerated or simplified manner for convenience of description. Furthermore, the dimension ratio between portions may differ between drawings.

The expression "tubular shape" as used herein encompasses not only shapes in which a circumferential wall is continuously formed over the entire circumferential direction, but also those in which a tubular shape is formed by combining multiple parts and those, such as a C shape, having a cutout, etc., in a part thereof in the circumferential direction. The expression "tubular shape" encompasses those having circular outer-circumferential shapes, elliptical outer-circumferential shapes, and polygonal outer-circumferential shapes with pointed or round corners; however, there is no limitation to such shapes. The expression "tubular shape" indicates shapes having a through-hole in a plan view, and encompasses those of which the outer-circumferential shape and the inner-circumferential shape of the through-hole are the same and those of which the outer-circumferential shape and the inner-circumferential shape of the through-hole differ from one another. The expression "tubular shape" encompasses those having a predetermined length along an axial direction in which the central axis passing through the center of the through-hole extends, and the length is not particularly limited (i.e., may be long or short). The expressions "opposing" and "facing" as used herein indicate that surfaces or members are positioned in front of one another, and encompass not only cases in which surfaces or members are positioned directly in front of one another, but also cases in which surfaces or members are partially positioned in front of one another. Furthermore, terms such as "first", "second", and "third" are used herein to merely distinguish objects from one another, and are not used to rank the objects. The present invention is not limited by the examples disclosed herein, and the scope of the present invention is intended to include all modifications that are indicated by the claims and are within the meaning and scope of equivalents of the claims.

### (Configuration of Connector Assembly 10)

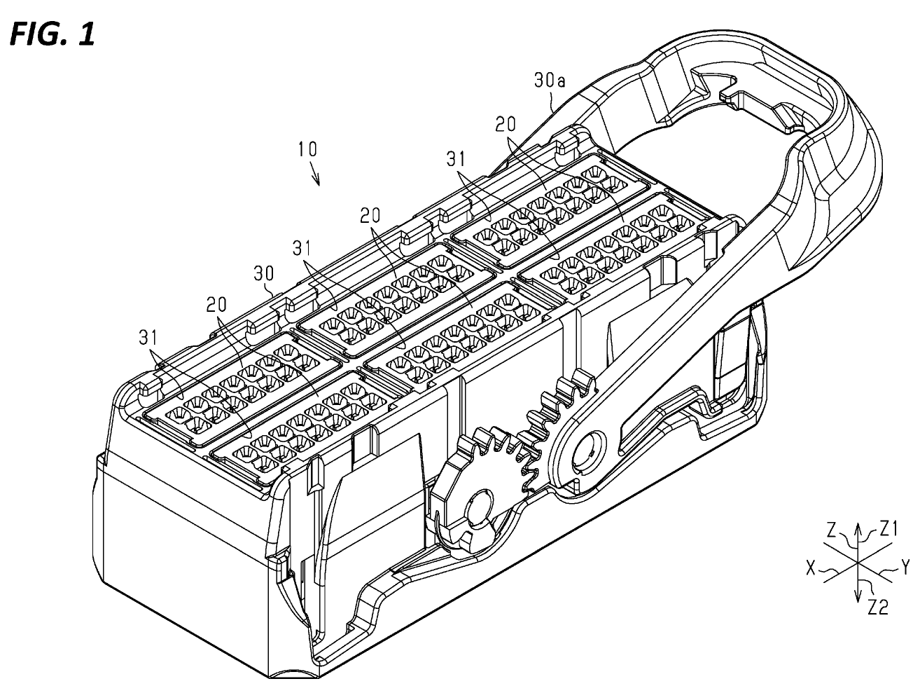

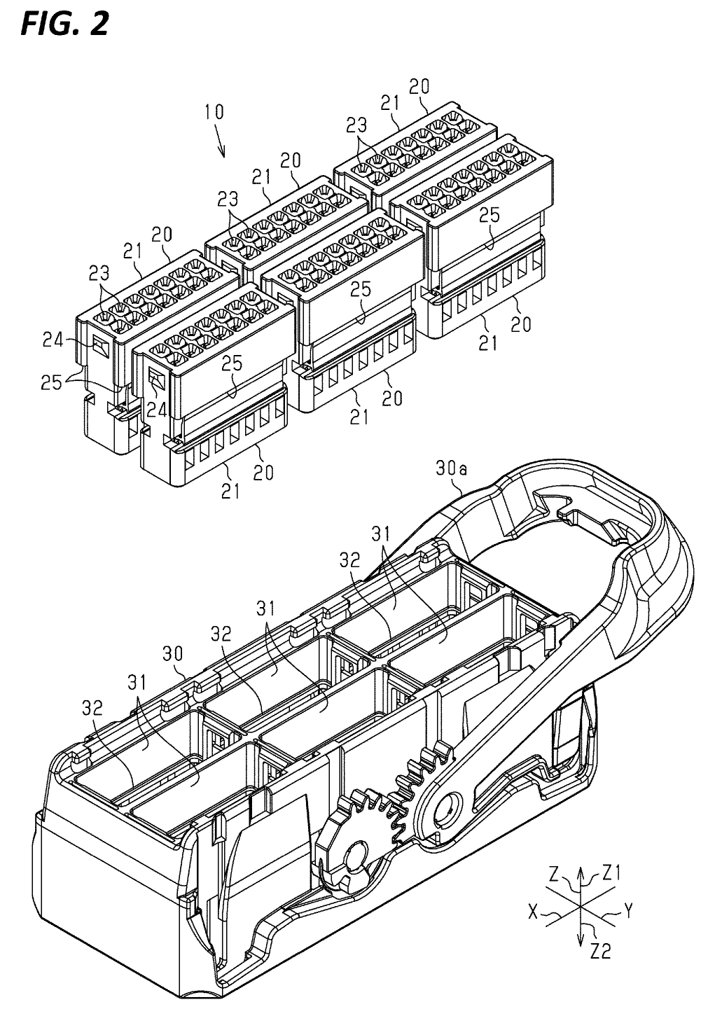

As illustrated in FIGS. 1 and 2, a connector assembly 10 includes a plurality of sub-connectors 20 and a frame 30. The connector assembly 10 according to the present embodiment includes six sub-connectors 20. For example, the connector assembly 10 is to be interposed in a path that electrically connects on-board devices provided in a vehicle with one another, and is to be fitted to an unillustrated mating connector. Note that, in each of the drawings, a first axis X, a second axis Y that is orthogonal to the first axis X, and a third axis Z that is orthogonal to the first axis X and the second axis Y and that is an insertion axis are illustrated. Furthermore, in the drawings, an upper direction Z1 that is one direction along the third axis Z and a lower direction Z2 that is the direction opposite to the upper direction Z1 are illustrated.

### (Configuration of Sub-Connector 20)

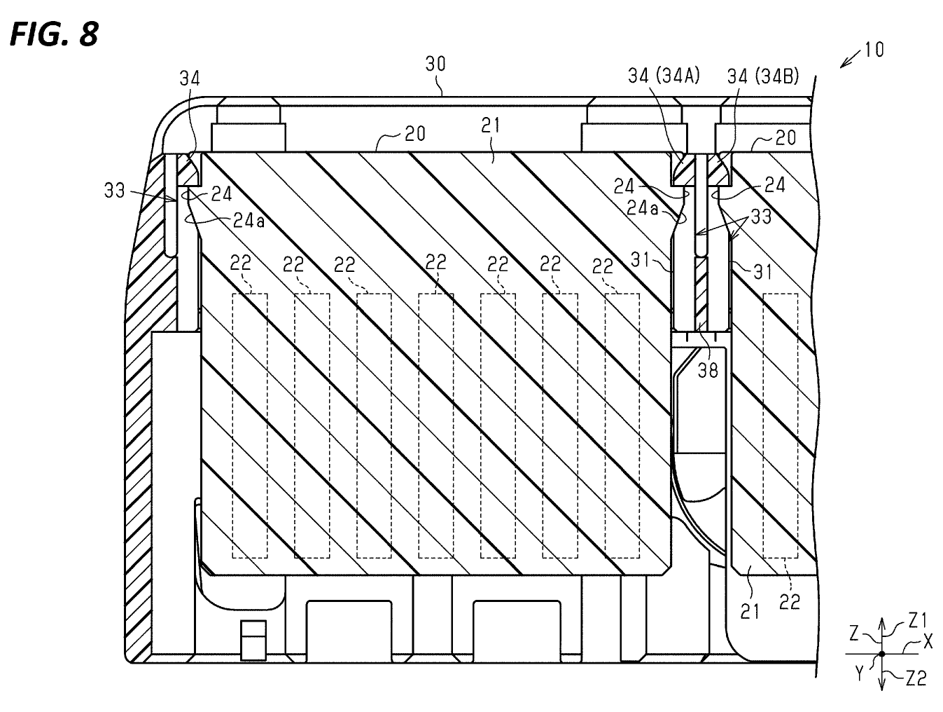

Each sub-connector 20 includes a connector housing 21 and a plurality of terminals 22 (see FIG. 8). The connector housing 21 is formed in a rectangular parallelepiped shape. The connector housing 21 has a plurality of terminal-accommodating holes 23 that pass therethrough along the third axis Z. As illustrated in FIG. 8, the plurality of terminals 22 extend along the third axis Z, and are accommodated and held within the terminal-accommodating holes 23 (see FIG. 2) in a state in which the terminals 22 are connected to unillustrated electric wires that extend in the upper direction Z1. Note that, for example, the terminals 22 according to the present embodiment are female terminals, and are configured to be capable of being fitted to unillustrated rod-shaped male terminals provided to the mating connector.

Furthermore, as illustrated in FIGS. 2 and 8, the connector housing 21 has a locking protrusion 24. The locking protrusion 24 projects in a direction intersecting the third axis Z. Specifically, the locking protrusion 24 is provided at a position of the connector housing 21 that is on the upper direction Z1 side along the third axis Z. Furthermore, the locking protrusion 24 is provided at both sides of the connector housing 21 along the first axis X, which is the long axis. The locking protrusion 24 includes an inclined surface 24a the projection amount of which gradually increases toward the upper direction Z1 from an end portion in the lower direction Z2 (see FIG. 8).

Furthermore, as illustrated in FIG. 2, the connector housing 21 has an abutting portion 25. The abutting portion 25 is provided at a middle portion of the connector housing 21 along the third axis Z. The abutting portion 25 is provided at both sides of the connector housing 21 along the second axis Y, which is the short axis. The abutting portion 25 is formed by the width, along the second axis Y, of the part of the connector housing 21 in the lower direction Z2 being reduced compared to that of the part of the connector housing 21 in the upper direction Z1.

### (Configuration of Frame 30)

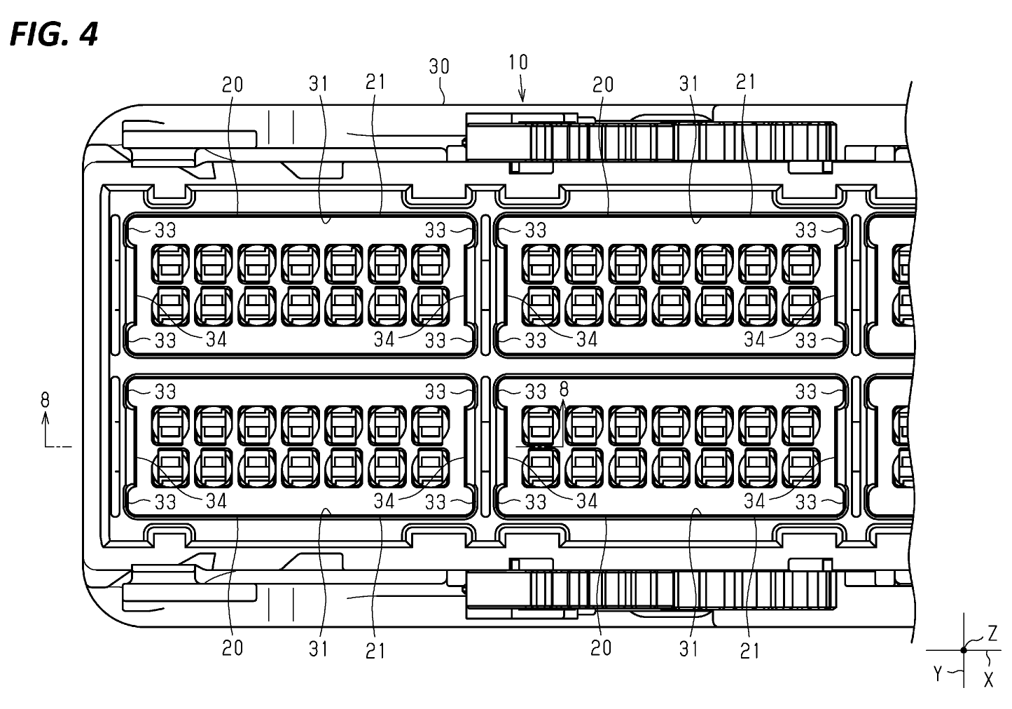

As illustrated in FIGS. 2 to 4, the frame 30 has a plurality of accommodating portions 31. The frame 30 according to the present embodiment has six accommodating portions 31. A total of six accommodating portions 31 are provided, by three accommodating portions 31 being provided next to one another along the first axis X and two accommodating portions 31 being provided next to one another along the second axis Y. Each of the accommodating portions 31 is configured so that the sub-connector 20 (see FIG. 2) can be inserted into the accommodating portion 31 along the third axis Z. That is, the accommodating portion 31 is formed in a rectangular tubular shape extending along the third axis Z. Furthermore, the frame 30 according to the present embodiment has a lever 30a, etc.; the lever 30a is used to attach and detach the connector assembly 10 to and from the mating connector.

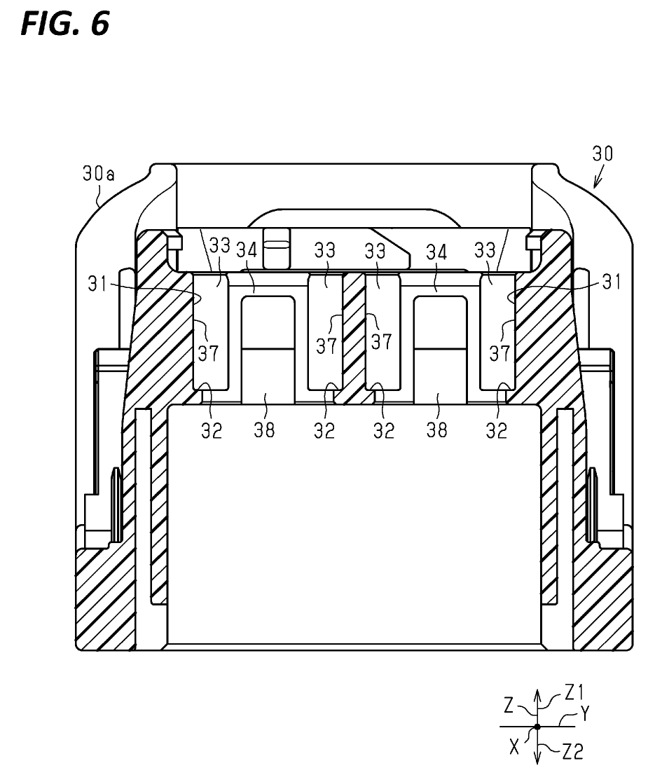

As illustrated in FIGS. 2, 5, and 6, the accommodating portion 31 has a receiving portion 32 that the abutting portion 25 abuts against in a completely inserted state in which the sub-connector 20 (see FIG. 2) has been inserted into the accommodating portion 31. In other words, the sub-connector 20 is configured to be capable of being inserted into the accommodating portion 31 to the completely inserted state, in which the abutting portion 25 abuts against the receiving portion 32. Note that, as illustrated in FIG. 8, the sub-connector 20 is configured so that, in the completely inserted state, an end portion in the lower direction Z2, which is the end portion that is inserted into the accommodating portion 31, is exposed without being covered by the accommodating portion 31.

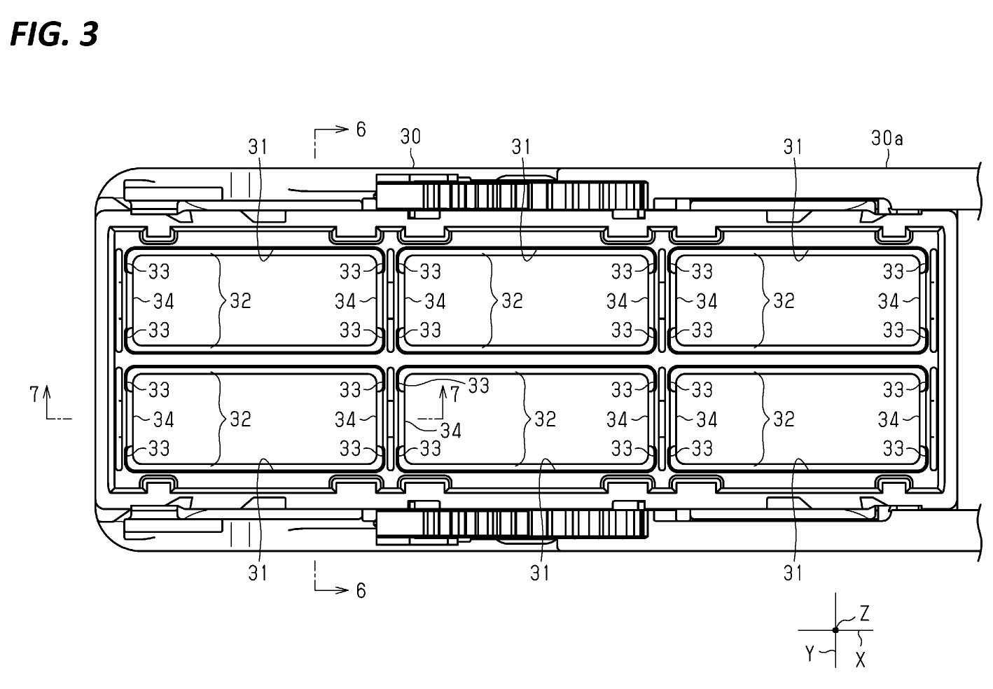

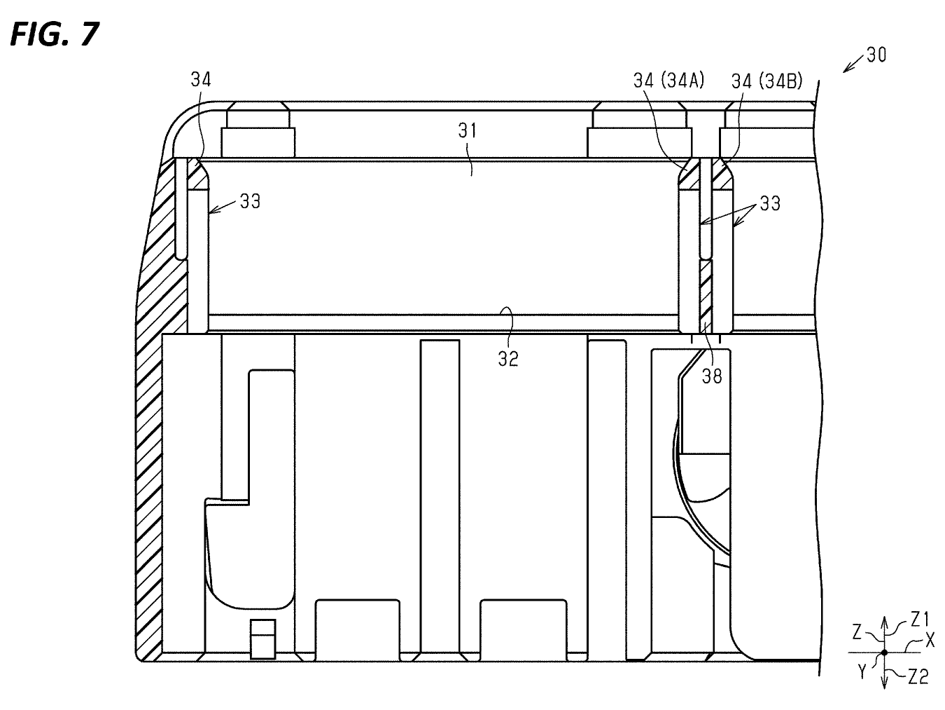

Furthermore, as illustrated in FIGS. 3 and 7, the plurality of accommodating portions 31 each have an elastic portion 33 and a lock claw 34. The elastic portion 33 and the lock claw 34 are provided at both sides of the accommodating portion 31 along the first axis X. Furthermore, the lock claw 34 is provided at an end portion of the accommodating portion 31 in the upper direction Z1, which is the end portion from which the sub-connector 20 is inserted (see FIG. 7). The lock claw 34 is configured to be capable of moving along the first axis X as a result of the elastic portion 33 bending.

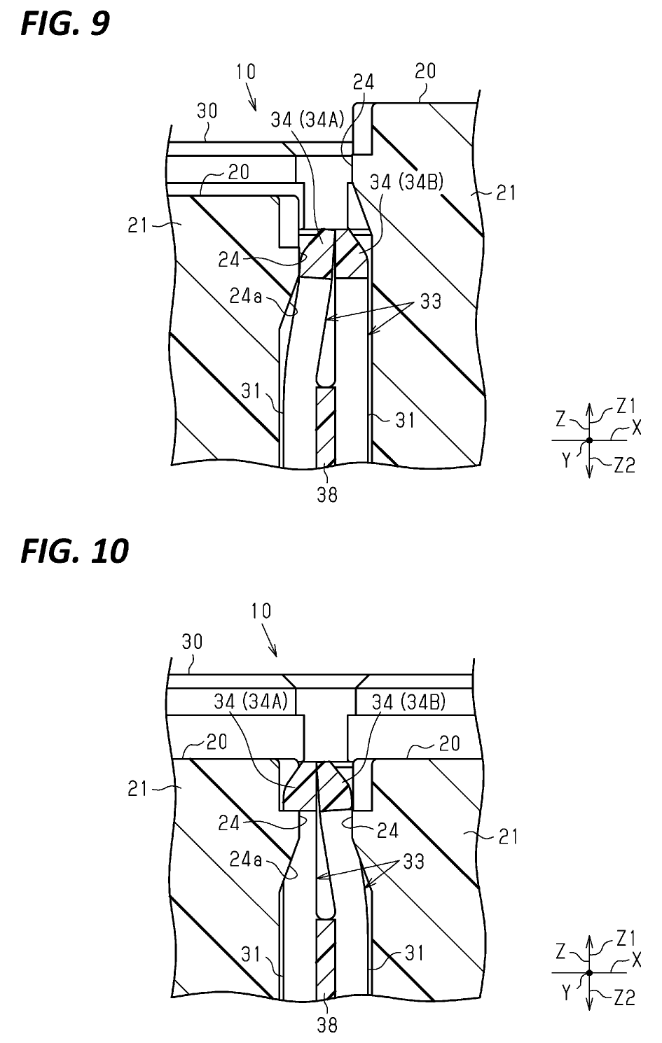

Specifically, as a result of the elastic portion 33 bending, the lock claw 34 moves from a normal position to a bent position (see the left-side lock claw 34 in FIG. 9) in which the lock claw 34 does not engage with the locking protrusion 24 in the direction along the third axis Z in a semi-inserted state during the insertion of the sub-connector 20 into the accommodating portion 31, for example. Note that the normal position as referred to here is a position of the lock claw 34 in an unloaded state in which no external force is applied to the elastic portion 33 or the lock claw 34.

Furthermore, as illustrated in FIG. 8, as a result of the lock claw 34 being positioned in the normal position in the completely inserted state, in which the sub-connector 20 has been inserted into the accommodating portion 31, the lock claw 34 engages with the locking protrusion 24 so as to prevent the disengagement of the sub-connector 20 from the accommodating portion 31.

Furthermore, as illustrated in FIGS. 9 and 10, the lock claw 34 includes a first lock claw 34A and a second lock claw 34B that are respectively provided to ones of the accommodating portions 31 that are adjacent along the first axis X such that the first lock claw 34A and the second lock claw 34B face one another between the adjacent accommodating portions 31. Note that "first" and "second" are included in the names of the first lock claw 34A and the second lock claw 34B for the sake of convenience in order to distinguish the two lock claws from one another in the following description, and a lock claw 34 may serve as the first lock claw 34A or the second lock claw 34B depending on the state thereof.

As illustrated in FIG. 9, the first lock claw 34A is provided so that the first lock claw 34A prevents the second lock claw 34B from moving to the bent position when the first lock claw 34A is in the bent position.

Furthermore, as illustrated in FIG. 10, the first lock claw 34A is provided so that the first lock claw 34A prevents the second lock claw 34B from moving beyond the bent position when the first lock claw 34A is in the normal position. Note that, while the sub-connector 20 has been inserted into the accommodating portion 31 having the first lock claw 34A in FIG. 10, the first lock claw 34A prevents the second lock claw 34B from moving beyond the bent position even in a state in which the sub-connector 20 has not been inserted. Note that, for example, FIG. 10 illustrates a state in which the second lock claw 34B has been moved using an unillustrated jig to pull out the sub-connector 20 from the accommodating portion 31 for maintenance, etc.

That is, the distance, etc., between the first lock claw 34A and the second lock claw 34B provided so as to face one another are set so that the first lock claw 34A and the second lock claw 34B restrict the movement of one another by coming into contact with one another depending on the states thereof. Note that the lock claws 34 at the ends along the first axis X, which do not face one another (see the lock claw 34 at the left end in FIG. 8), do not function as the first lock claw 34A or the second lock claw 34B in the manner described above.

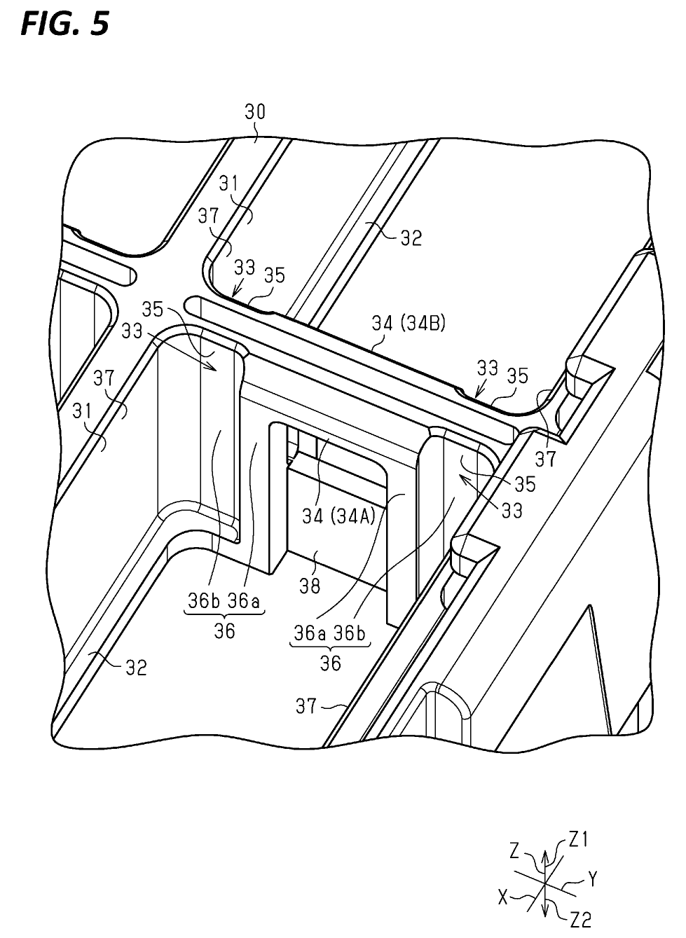

As illustrated in FIG. 5, the elastic portion 33 is provided at both sides of the lock claw 34. The elastic portion 33 according to the present embodiment includes a pair of side elastic walls 35 provided at opposite sides of the lock claw 34. Furthermore, the elastic portion 33 according to the present embodiment includes a pair of insertion-axis elastic walls 36 provided at the opposite sides of the lock claw 34.

The pair of side elastic walls 35 extend from the opposite sides of the lock claw 34 in directions along the second axis Y that are directions away from one another, and are connected to a pair of opposing surfaces 37 forming the inner surface of the accommodating portion 31. The side elastic walls 35 according to the present embodiment are formed so that the thickness thereof along the first axis X is thinner than that of the lock claw 34.

Furthermore, the pair of insertion-axis elastic walls 36 extend from the side elastic walls 35 and the opposite sides of the lock claw 34 in the lower direction Z2, which is a direction along the third axis Z. The pair of insertion-axis elastic walls 36 according to the present embodiment include thick elastic walls 36a that extend in the lower direction Z2 from the opposite sides of the lock claw 34, and thin elastic walls 36b that extend in the lower direction Z2 from the side elastic walls 35. Furthermore, end portions of the pair of insertion-axis elastic walls 36 according to the present embodiment in the lower direction Z2 are connected by a connecting portion 38.

### (Actions of Connector Assembly 10)

Next, the actions of the connector assembly 10 configured as described above will be described.

In the connector assembly 10 configured as described above, the sub-connector 20 is attached to the frame 30. The sub-connector 20 is inserted into the accommodating portion 31 by being moved relative to the frame 30 in the lower direction Z2 along the third axis Z. The sub-connector 20 is placed in the completely inserted state by the abutting portion 25 abutting against the receiving portion 32. The sub-connector 20 placed in the completely inserted state is prevented from being disengaged from the accommodating portion 31 by the locking protrusion 24 engaging with the lock claw 34.

The connector assembly 10 is fitted to the unillustrated mating connector by being moved relative to the mating connector in the lower direction Z2 along the third axis Z. Then, the terminals 22 held by each sub-connector 20 are fitted and electrically connected to the unillustrated mating terminals of the mating connector.

### (Effects of Present Embodiment)

Next, the effects of the above-described embodiment will be described in the following.

(1) The first lock claw 34A prevents the second lock claw 34B from moving to the bent position when the first lock claw 34A is in the bent position (see FIG. 9). Accordingly, for example, the sub-connector 20 can be prevented from being inserted into the accommodating portion 31 having the second lock claw 34B when the first lock claw 34A is in the bent position. Accordingly, for example, a worker can sense that the sub-connector 20 is in the semi-inserted state in the accommodating portion 31 having the first lock claw 34A based on the insertion of the sub-connector 20 to the accommodating portion 31 having the second lock claw 34B being impossible.

Furthermore, the first lock claw 34A prevents the second lock claw 34B from moving beyond the bent position when the first lock claw 34A is in the normal position (see FIG. 10). Accordingly, for example, a situation such as that in which the elastic portion 33 connected to the second lock claw 34B is damaged by being bent excessively can be prevented. In particular, there are cases in which a large force is applied to the second lock claw 34B by a jig when the sub-connector 20 is pulled out from the accommodating portion 31 for maintenance, etc.; even in such a case, the elastic portion 33 connected to the second lock claw 34B can be prevented from being bent excessively.

Furthermore, the elastic portion 33 is provided at both sides of the lock claw 34; thus, a situation in which the elastic portion 33 is bent significantly under a small force can be reduced compared to a case in which the elastic portion 33 is a single elastic piece that is connected to the lock claw 34 and that bends in a tilting manner by being connected to a single fulcrum, for example. Accordingly, for example, a situation in which the second lock claw 34B moves beyond the bent position when the first lock claw 34A is in the normal position can be firmly prevented. Due to the above, the elastic portion 33 is less susceptible to damage, and, consequently, the sub-connector 20 can be held stably.

(2) The elastic portion 33 includes a pair of side elastic walls 35 that extend in directions away from one another from opposite sides of the lock claw 34 and that are connected to a pair of opposing surfaces 37 forming an inner surface of the accommodating portion 31; thus, a situation in which the elastic portion 33 is bent significantly under a small force can be suppressed. That is, unlike a single elastic piece that is connected to the lock claw 34 and that bends in a tilting manner by being connected to a single fulcrum, for example, the pair of side elastic walls 35 do not readily bend due to the interaction therebetween, even though the side elastic walls 35 are configured to be thin. Accordingly, for example, a situation in which the second lock claw 34B moves beyond the bent position when the first lock claw 34A is in the normal position is firmly prevented. Due to the above, the elastic portion 33 is even less susceptible to damage, and, consequently, the sub-connector 20 can be held more stably.

(3) The elastic portion 33 includes a pair of insertion-axis elastic walls 36 that extend along the third axis Z from the side elastic walls 35 and the opposite sides of the lock claw 34; thus, a situation in which the elastic portion 33 is bent significantly under a small force can be reduced to a further extent compared to a configuration in which the insertion-axis elastic walls 36 are not included, for example.

(4) The lock claw 34 is provided at an end portion of the accommodating portion 31 from which the sub-connector 20 is inserted; thus, for example, a worker can visually check whether or not the lock claw 34 is in the normal position from the direction in which the sub-connector 20 has been inserted into the accommodating portion 31. Accordingly, for example, after inserting the sub-connector 20 into the accommodating portion 31, the worker can easily check whether the sub-connector 20 is in the completely inserted state or the semi-inserted state without turning over the connector assembly 10.

(5) The sub-connector 20 has an abutting portion 25 at a middle portion thereof along the third axis Z, and the accommodating portion 31 has a receiving portion 32 that the abutting portion 25 abuts against when the sub-connector 20 is in the completely inserted state. Accordingly, an end portion of the sub-connector 20 in the lower direction Z2, which is the end portion that is inserted into the accommodating portion 31, can be exposed. In other words, a configuration can be obtained in which the end portion of the sub-connector 20 in the lower direction Z2 is not covered by the accommodating portion 31. Accordingly, in comparison with a configuration in which the end portion of the sub-connector 20 in the lower direction Z2 is covered by the accommodating portion 31, for example, the effective contact length between terminals 22 held by the sub-connector 20 and mating terminals of the mating connector can be increased. That is, with a configuration in which the end portion of the sub-connector 20 in the lower direction Z2 is covered by the accommodating portion 31, it would be difficult to increase the effective contact length with the mating terminals because the terminals 22 would be located further inward; however, the effective contact length can be increased by avoiding such a situation.

### (Modifications)

The above-described embodiment can be implemented so as to be modified as follows. The above-described embodiment and the following modifications may be implemented so as to be combined with one another as long as there is no technical contradiction.

In the above-described embodiment, the elastic portion 33 includes a pair of side elastic walls 35 that extend in directions away from one another from opposite sides of the lock claw 34 and that are connected to a pair of opposing surfaces 37 forming an inner surface of the accommodating portion 31; however, there is no limitation to this. For example, the elastic portion 33 may also be configured into other elastic portions 33 that extend in different directions from the side elastic walls 35 and that are connected to other parts.

In the above-described embodiment, the elastic portion 33 includes a pair of insertion-axis elastic walls 36 that extend along the third axis Z from the side elastic walls 35 and the opposite sides of the lock claw 34; however, there is no limitation to this, and a configuration in which the insertion-axis elastic walls 36 are not included may also be adopted, for example. Furthermore, it has been indicated that the pair of insertion-axis elastic walls 36 include thick elastic walls 36a that extend in the lower direction Z2 from the opposite sides of the lock claw 34, and thin elastic walls 36b that extend in the lower direction Z2 from the side elastic walls 35; however, there is no limitation to this, and the thicknesses of such elastic walls may also be changed, for example.

In the above-described embodiment, the lock claw 34 is provided at an end portion of the accommodating portion 31 in the upper direction Z1, which is the end portion from which the sub-connector 20 is inserted; however, there is no limitation to this, and the lock claw 34 may also be provided at an end portion of the accommodating portion 31 in the lower direction Z2, for example.

In the above-described embodiment, the sub-connector 20 has an abutting portion 25 at a middle portion thereof along the third axis Z; however, there is no limitation to this, and a configuration may also be adopted in which an end portion of the sub-connector 20 in the lower direction Z2 abuts against the accommodating portion 31, for example. That is, a configuration may also be adopted in which the end portion of the sub-connector 20 in the lower direction Z2 is covered by the accommodating portion 31.

In the above-described embodiment, the frame 30 has six accommodating portions 31; however, there is no limitation to this. The number of accommodating portions 31 that the frame 30 has may also be changed into other numbers, as long as a plurality of accommodating portions 31 are provided. Furthermore, the number of sub-connectors 20 included in the connector assembly 10 may also be changed, as a matter of course.

The embodiment disclosed herein is an example in every way, and the present invention is not limited by such examples. That is, the scope of the present invention is intended to include all modifications that are indicated by the claims and are within the meaning and scope of equivalents of the claims.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector assembly comprising:
a frame that has a plurality of accommodating portions; and
a sub-connector that is configured to be capable of being inserted along an insertion axis to each of the plurality of accommodating portions, the sub-connector having a locking protrusion that projects in a direction intersecting the insertion axis,
wherein each of the plurality of accommodating portions has an elastic portion and a lock claw,
as a result of the elastic portion bending, the lock claw moves from a normal position to a bent position in which the lock claw does not engage with the locking protrusion, and, as a result of being positioned in the normal position in a completely inserted state in which the sub-connector has been inserted into the accommodating portion, the lock claw engages with the locking protrusion so as to prevent disengagement of the sub-connector from the accommodating portion,
the lock claw includes a first lock claw and a second lock claw that are respectively provided to adjacent ones of the accommodating portions such that the first lock claw and the second lock claw face one another between the adjacent accommodating portions,
the first lock claw is provided so that the first lock claw prevents the second lock claw from moving to the bent position when the first lock claw is in the bent position, and the first lock claw prevents the second lock claw from moving beyond the bent position when the first lock claw is in the normal position, and
the elastic portion is provided at both sides of the lock claw.

2. The connector assembly according to claim 1,
wherein the elastic portion includes a pair of side elastic walls that extend in directions away from one another from opposite sides of the lock claw and that are connected to a pair of opposing surfaces forming an inner surface of the accommodating portion.

3. The connector assembly according to claim 2,
wherein the elastic portion includes a pair of insertion-axis elastic walls that extend along the insertion axis from the side elastic walls and the opposite sides of the lock claw.

4. The connector assembly according to claim 1,
wherein the lock claw is provided at an end portion of the accommodating portion from which the sub-connector is inserted.

5. The connector assembly according to claim 1,
wherein the sub-connector has an abutting portion at a middle portion thereof along the insertion axis, and
the accommodating portion has a receiving portion that the abutting portion abuts against in the completely inserted state, in which the sub-connector has been inserted into the accommodating portion.
